(19) United States
(12) Patent Application Publication
(10) Pub. No.: US 2025/0377968 A1
(43) Pub. Date: Dec. 11, 2025

(54) SWARM TECHNIQUES FOR ROOT CAUSE ANALYSIS

(71) Applicant: Intel Corporation, Santa Clara, CA (US)

(72) Inventors: Mario Jose Divan, Hillsboro, OR (US); Addicam Sanjay, Chandler, AZ (US); John Joseph Browne, Limerick (IE); Marcos Emanuel Carranza, Portland, OR (US); Nicholas Gordon Ross, Lake Forest, CA (US)

(73) Assignee: Intel Corporation, Santa Clara, CA (US)

(21) Appl. No.: 19/313,376

(22) Filed: Aug. 28, 2025

(51) Int. Cl. G06F 11/07; G06N 3/0455

(52) U.S. Cl. CPC G06F 11/079; G06N 3/0455

(57) ABSTRACT

Example systems, apparatus (e.g., compute devices), articles of manufacture, and methods are disclosed to implement swarm techniques for root cause analysis. An example compute device disclosed herein joins a swarm of compute devices, the swarm of compute devices to maintain a distributed database including an artificial intelligence model associated with anomaly detection. The disclosed example compute device also obtains the artificial intelligence model from the distributed database, and performs a root cause analysis based on the artificial intelligence model.

### BACKGROUND

Several factors can affect compute device operation and lead to anomalous behavior. Root cause analysis involves determining the underlying cause(s) of one or more compute device operating anomalies such that the anomalies can be prevented and/or corrective action can be taken.

### BRIEF DESCRIPTION OF THE DRAWINGS

FIG. 1 is a block diagram of an example environment including example swarms of compute devices that cooperate to perform root cause analysis in accordance with teachings of this disclosure.

FIG. 2 is a block diagram of an example implementation of an example compute device included in one of the device swarms of FIG. 1.

FIG. 3 is a sequence diagram illustrating an example procedure performed by the compute device of FIG. 2 to join a swarm of compute devices.

FIG. 4 is a sequence diagram illustrating an example procedure performed by the compute device of FIG. 2 to cause an existing swarm of compute devices to be split into multiple swarms of compute devices.

FIG. 5 is a sequence diagram illustrating an example procedure performed by the compute device of FIG. 2 to activate an example swarm root cause analysis agent.

FIG. 6 is a sequence diagram illustrating an example procedure performed by the compute device of FIG. 2 to cause an artificial intelligence model to be trained by a swarm of compute devices.

FIGS. 7-8 are flowcharts representative of example machine readable instructions and/or example operations that may be executed, instantiated, and/or performed by example programmable circuitry to implement the example compute device of FIG. 2.

FIG. 9 is a block diagram of an example processing platform including programmable circuitry structured to execute, instantiate, and/or perform the example machine readable instructions and/or perform the example operations of FIGS. 7-8 to implement the SRCA engine and/or the SRCA agent of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 7-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Root cause analysis involves determining the cause(s) of an observed or potential compute device operating anomaly such that the anomaly can be prevented and/or corrective action can be taken. A cause of an observed or potential compute device operating anomaly can be tied to a one or more factors that affect compute device operation. Silicon aging is one such factor that can affect device reliability, which may limit the ability of the device to satisfy service level objectives (SLOs) and associated service level agreements (SLAs). Operating environment factors, such as weather conditions, enclosure humidity and/or temperature control failures, power fluctuations, etc., can also negatively impact device performance, reliability, etc. By identifying a root cause of actual or potential anomalous device operation, action can be undertaken to mitigate or even avoid such problems and, thus, extend devices lifespan, avoid additional operating expenditures associated with device repair and replacement, reduce total cost of ownership, etc.

Some root cause analysis techniques, such as at least some example swarm techniques disclosed herein, employ a manageability engine, or similar structure, embedded in or otherwise provided by a compute device to provide management features (also referred to herein as administrative features) to monitor and control device operation. Some such manageability engines generate event logs and/or audit logs to monitor operation of components of the compute device, such as one or more memories, one or more storage devices, one or more central processing units (CPUs), one or more processor cores, a basic input/output system (BIOS) of the compute device, one or more system boards of the compute device, etc. Some such manageability engines utilize one or more application programming interface(s) (APIs) and/or other tools to report the generated logs to a remote management, or administrative, console. Additionally or alternatively, some such manageability engines utilize out-of-band (OOB) processing and communication resources included in the compute device to enable such monitoring (e.g., logging) and reporting to occur without reliance on the operating system and/or processing resources (e.g., CPUs, memory, etc.) of the compute device. For example, some manageability engines can perform monitoring (e.g., logging) and reporting even when an operating system (OS) of the compute device is not active (e.g., is not running on the compute device).

Furthermore, some manageability engines with OOB capability utilize the OOB processing and communication resources to provide a connection to the remote management, or administrative, console, to perform root cause analysis. For example, the manageability engine may support a subscription mechanism to push logs and/or other monitoring data (e.g., events) to a remote management console or other endpoint. An administrator operating the remote management console may invoke one or more tools to process the logs and/or other monitoring data reported by the compute device to detect an operational anomaly and determine an underlying root cause. The administrator, via the remote management console, may further initiate one or more communication sessions with the compute device to mitigate or resolve the detected operational anomaly.

Example root cause analysis solutions disclosed herein provide further features, including but not limited to manageability engine enhancements, that enable a compute device to perform root-cause analysis autonomously at the compute device itself without reliance on a connection to a remote management console or similar endpoint. Example root cause analysis solutions disclosed enable compute devices to form swarms of devices and develop an associated swarm intelligence for root cause analysis. A swarm of devices can be a collection, grouping, etc., of multiple (e.g., two or more) devices. The swarm intelligence can include information shared among the swarm of compute devices, artificial intelligence (AI) models shared and/or updated among the swarm of computed devices, etc. For example, by sharing monitored logs and/or other data, recipes for identifying root causes of detected anomalies, recipes for mitigating and/or avoiding the detected anomalies based on the identified root causes, etc., the swarm of compute devices can develop and grow a knowledge base for root cause analysis. Also, in some examples, the swarm of compute devices share and jointly update one or more AI models used to perform anomaly detection, root cause path analysis, etc., further enhancing the swarm intelligence available to the individual compute devices of the swarm. As such, example root cause analysis solutions disclosed herein enable compute devices to form swarms that can converge to a self-adaptative, self-organized, and shareable intelligence that is available for any swarm member as an auto-recovery mechanism against detected anomalies, such as crashes, cold-start scenarios, etc.

In example root cause analysis solutions disclosed herein, example compute devices include example manageability engines that allow the compute devices to autonomously and dynamically discover and associate with one another as a swarm (or other logical region, group, etc.) based on one or more configurable criteria, such as device similarity. Disclosed example manageability engines also allow the compute devices of a swarm to share AI models, recipes, monitored logs, inventory information, etc., to facilitate anomaly detection, and root cause analysis and mitigation. In some examples, a swarm of compute devices forms a distributed database, which in some examples may be blockchain-based, to share information without centralized control, fostering auto-recovery mechanisms against system crashes and addressing cold-start scenarios in the swarm.

In example root cause analysis solutions disclosed herein, example compute devices may also include root cause analysis agents that implement advanced root cause analysis features in a swarm of compute devices. For example, such agents may enable a swarm of compute devices to collectively share and retrain one or more AI models used to perform anomaly detection, root cause path analysis, etc. Such retraining can result in AI models that are tailored to the specific characteristics of the compute devices included in a given swarm, thereby improving the accuracy of anomaly detection, root cause path analysis, etc., relative to general purpose AI models.

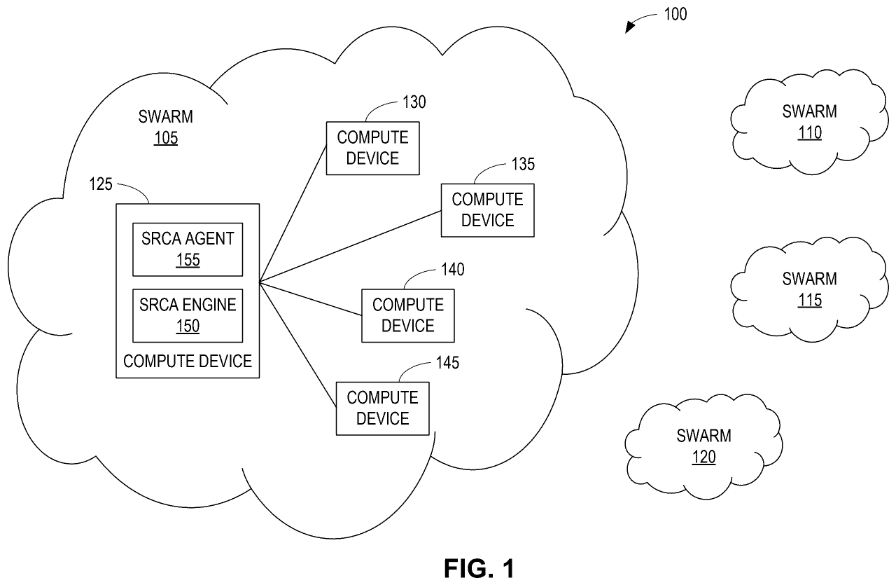

Turning to the figures, FIG. 1 is a block diagram of an example environment 100 including example swarms of compute devices that cooperate to perform root cause analysis in accordance with teachings of this disclosure. In the illustrated example environment 100 of FIG. 1, compute devices autonomously form example device swarms 105-120 to perform root cause analysis. For example, compute devices 125-145 autonomously form the device swarm 105 to develop a collective swarm intelligence that is available to the compute devices 125-145 to facilitate local anomaly detection, local root cause path analysis and identification, local root cause mitigation and/or avoidance, etc., at the individual compute devices 125-145. The compute devices 125-245 can be any type of compute device, and some or all of the compute devices 125-145 can be different types of compute devices (e.g., such that a given swarm may include heterogenous compute devices). For example, the compute devices 125-245 can be servers, personal computers, workstations, self-learning machines (e.g., a neural networks), mobile devices (e.g., a cell phone, a smart phone, a tablet such as an iPad™), personal digital assistants (PDAs), an Internet appliances, gaming consoles, headsets (e.g., an augmented reality (AR) headset, a virtual reality (VR) headset, etc.), wearable devices, etc.

In the example of FIG. 1, the compute device 125 includes an example management engine 150, also referred to as an example swarm root cause analysis (SRCA) engine 150, to implement swarm root cause analysis in accordance with teachings of this disclosure. In some examples, the compute device 125 optionally includes an example agent 155, also referred to as an example SRCA agent 155, to also implement swarm root cause analysis in accordance with teachings of this disclosure. The SRCA engine 150 and/or the SRCA agent 155 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the SRCA engine 150 and/or the SRCA agent 155 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the illustrated example, the SRCA engine 150 implements an OOB communication interface to permit the compute device 125 to communicate with other compute devices, such as the compute devices 130-145, to form the device swarm 105. For example, the OOB communication interface implemented by the SRCA engine 150 may be a wireless communication interface that supports one or more communication protocols, such as Transmission Control Protocol (TCP)/Internet Protocol (IP), referred to as TCP/IP, User Datagram Protocol (UDP), etc., and which is distinct from other communication interface(s) implemented by the compute device 125. In the illustrated example, communication interface implemented by the SRCA engine 150 is referred to as OOB because it is self-reliant and may not utilize OS resources and/or other processing resources (e.g., CPUs, memory, etc.) of the compute device 125. In some examples, the OOB communication interface implemented by the SRCA engine 150 is operable without an OS of the compute device 125 being active and, thus, is available after power is applied to the compute device 125 and before the compute device 125 boots up and is ready for normal operation. In other words, the OOB communication interface implemented by the SRCA engine 150 is separate from other communication interface(s) implemented by the compute device 125 and accessible via its OS. In general, communications between the compute device 125 and other compute devices for the purposes of swarm-based root cause analysis, as disclosed herein, occur over the OOB communication interface.

In the illustrated example, the compute device 125 uses its SRCA engine 150 to communicate via the OOB communication interface with one or more other compute devices, such as the compute device 130, to join the device swarm 105. For example, the compute device 125 and the compute device 130 may share device inventory information and perform a similarity analysis to determine whether the compute device 125 has sufficient similarity (e.g., in terms of device components, characteristics, behaviors, etc.) with the compute device 130 and/or the other compute devices 135-145 already in the swarm 105 to join the swarm 105. In some examples, the compute device 125 also uses its SRCA engine 150 to manage membership in the device swarm 105, which may include splitting the swarm 105 into multiple swarms as membership evolves to yield device swarms having closely aligned device characteristics. Further details concerning swarm formation and management are provided below.

In the illustrated example, the compute device 125 uses its SRCA engine 150 to access and maintain a distributed database associated with the device swarm 105. For example, the compute devices 125-145 in the device swarm 105 maintain a distributed database, and/or other distributed mechanism for exchanging information, to share AI models, recipes, monitored logs, inventory information, etc., to facilitate anomaly detection, and root cause analysis and mitigation in the device swarm 105. In some examples, the compute devices 125-145 in the device swarm 105 implement a blockchain-based distributed mechanism that uses a blockchain to enable management of the distributed database to be distributed among the compute devices 125-145. For example, blockchain techniques can be used to add information to the distributed database, govern access to information in the database, validate information accessed from the database, etc.

By way of example, the SRCA engine 150 of the compute device 125 can cause a request to be communicated to the other compute devices 130-145 of the device swarm 105 to add data (e.g., such as a data record associated with a recipe, inventory data, an AI model) to the distributed database maintained by the swarm 105. In some such examples, the SRCA engine 150 of the compute device 125 evaluates responses from the compute devices 130-145 containing the results of the request to determine whether the data is permitted to be added to the distributed database. For example, the results provided in the responses from the compute devices 130-145 may be respective votes approving or disapproving the request to add the data. In some examples, the results may also include weights that are based on similarity computations between the compute device 125 and respective ones of the compute devices 130-145 in the swarm 105. For example, the weight associated with the voting result from the compute device 130 may be based on a similarity computed between the inventory details of the compute device 130 and the inventory details of the compute device 125 such that the weight is proportional to how similar the compute device 130 is to the compute device 125.

In some examples, the compute devices 125-145 store local copies of the distributed database. In some examples, the local copies of the distributed database stored at the compute devices 125-145 may include public information accessible to any device in the swarm 105, as well as private information accessible locally by just the respective compute device 125-145. For example, the compute device 125 uses its SRCA engine 150 to access public information from a copy of the distributed database maintained by the compute device 130 in the swarm 105, and then augments the public information with private information accessible by just the compute device 125 to create and update a local copy of the distributed database at the compute device 125. Further details concerning distributed database management are provided below.

In the illustrated example, the compute device 125 uses its SRCA engine 150 to obtain one or more AI models from the distributed database maintained by the device swarm 105. For example, the compute device 125 may obtain one or more of the AI models from a local copy of the distributed database maintained by its SRCA engine 150, and/or may obtain one or more of the AI models from a copy of the distributed database maintained by another device in the swarm 105, such as the device 130. In some examples, the AI model(s) obtained by the compute device 125 using its SRCA engine 150 include a first AI model associated with anomaly detection and/or a second AI model associated with root cause path analysis. In some such examples, the compute device 125 uses its SRCA engine 150 to perform a root cause analysis procedure at the compute device based on the first AI model and/or the second AI model.

For example, the SRCA engine 150 executes or otherwise invokes the first AI model to process device metrics obtained from logs and/or other monitored data of the compute device 125 to perform anomaly detection. In some such examples, an output of the first AI model may be a value, such as a probability, that the compute device 125 has or is predicted to experience an operational anomaly. For example, the operational anomaly can correspond to failure or performance degradation of one or more memories, processor cores, subsystems, etc., of the compute device. In some examples, the SRCA engine 150 utilizes the output of the first AI model as a trigger to perform further root cause analysis (e.g., such as by triggering further root cause analysis if the output of the first AI model satisfies (e.g., meets or exceeds) a threshold).

In some examples, the SRCA engine 150 executes or otherwise invokes the second AI model if further root cause analysis is triggered based on the first AI model. In some such examples, the second AI model is trained to predict a next device state based on a current device state of the compute device 125. For example, when further root cause analysis is triggered based on the output of the first AI model, the SRCA engine 150 may initiate a path analysis of a graph to determine the current device state of the compute device 125. In some such examples, the graph may be representative of potential states and state transitions associated with operation of the compute device 125. In some such examples, the SRCA engine 150 may perform path analysis by traversing the graph based on logged data (e.g., logs, monitored data, etc.) generated by the compute device 125. The SRCA engine 150 may then execute or otherwise invoke the second AI model to predict the next device state of the compute device 125 based on the current device state determined from the path analysis. In some examples, the predicted next device state is used by the SRCA engine 150 to identify a root cause of the actual or predicted operational anomaly detected by the first AI model.

For example, the SRCA engine 150 of the compute device 125 may query the distributed database maintained by the device swarm 105 for a recipe to identify a root cause associated with the predicted next device state of the compute device 125. In some examples, the SRCA engine 150 may query a local copy of the database maintained by the SRCA engine 150 and/or query one or more copies of the database maintained by other ones of the compute devices 130-145 in the device swarm 105. In some examples, the query is based on the predicted next device state of the compute device 125 to return recipes associated with the likely next state of the compute device 125 (e.g., to return recipe(s) tailored to mitigate operation at that next device state and/or to avoid transitioning to that predicted next device state). In some examples, the query is additionally or alternatively based on a device inventory associated with the compute device 125 (e.g., to return recipe(s) also tailored for devices with similar device characteristics). In some examples, if the query of the distributed database maintained by the device swarm 105 is unsuccessful (e.g., does not return a recipe meeting the query criteria), the SRCA engine 150 of the compute device 125 may contact other compute device(s) in one or more of the other swarm(s) 110-120 (e.g., referred to as ambassadors in the description below) to attempt to obtain recipe(s) for root cause analysis. Further details concerning root-cause analysis procedures performed by the SRCA engine 150 are provided below.

In the illustrated example, SRCA agent 155 of the compute device 125 implements further procedures to support root cause analysis at the compute device 125. In some examples, the SRCA agent 155 accesses resources of the compute device 125 via the device's OS to implement computationally intensive procedures that exceed the capabilities of the SRCA engine 150. For example, the SRCA agent 155 of the illustrated example cooperates with the SRCA agents of the other compute devices 130-145 in the device swarm 105 to train/update one or more of the AI models maintained in the swarm's distributed database. In some such examples, the SRCA agent 155 can train an AI model locally at the compute device 125 using compute and memory resources of the compute device 125 and training data (e.g., logged data) generated at the compute device 125. In some examples, the SRCA agent 155 may manage/coordinate the training of an AI model by distributing the training to one or more of the other compute devices 130-145 in the swarm 105, and then update the AI model by unifying (e.g., combining/merging) the training results from the other compute device(s) 130-145. Further details concerning functionality of the SRCA agent 155 are provided below.

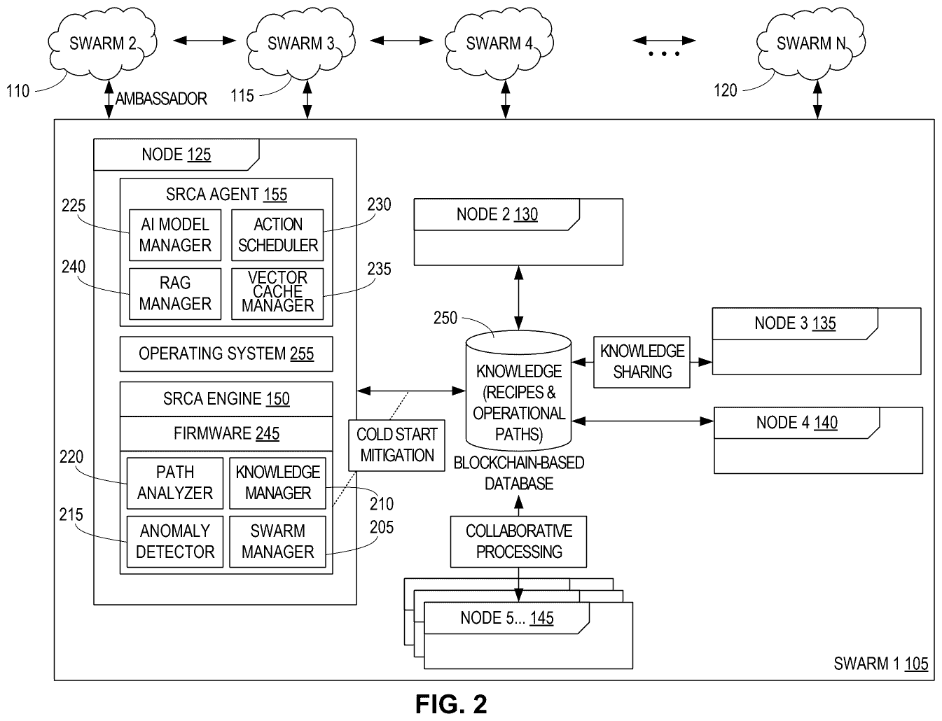

FIG. 2 is a block diagram of an example implementation of compute device 125 included in the example swarm 105 of FIG. 1. The compute device 125 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the compute device 125 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example compute device 125 of FIG. 2 includes an example implementation of the SRCA engine 150 and an example implementation of the example SRCA agent 155 introduced above in connection with the description of FIG. 1. The example SRCA engine 150 of FIG. 2 includes example swarm manager circuitry 205, example knowledge manager circuitry 210, example anomaly detector circuitry 215 and example path analyzer circuitry 220. The example SRCA agent 155 of FIG. 2 includes example AI model manager circuitry 225, example action scheduler circuitry 230, example vector cache manager circuitry 235 and example retrieval augmented generation (RAG) manager circuitry 240.

In the illustrated example of FIG. 2, the SRCA engine 150 augments a management engine that provides remote OOB management of the compute device 125. For example, the SRCA engine 150 may be implemented by example firmware 245 and/or the example circuitry 205-220 to augment a management engine such as the management engine included in Intel's® Active Management Technology (AMT) solution. In some such examples, the SRCA engine 150 becomes operative after the management engine of the compute device 125 is onboarded such that the compute device 125 is operating in a OOB managed mode, such as the Administrative Control Mode (ACM) of Intel's® AMT solution. Such onboarding may ensure that the compute device 125 is trusted and the OOB communication interface is active and able to send and receive communications with other onboarded compute devices. In this way, communications between the compute device 125 and other compute devices for the purposes of swarm-based root cause analysis, as disclosed herein, occur over the OOB communication interface.

In the illustrated example of FIG. 2, compute devices autonomously form the device swarms 105-120 described above to perform root cause analysis. In the description of FIG. 2, compute devices are also referred to more generally as nodes, and the swarms may also be referred to as regions, logical regions, logical groups, etc. In the illustrated example, a swarm, such as the swarm 105, includes onboarded compute devices, such as the compute devices 125-145. As described above, the compute devices 125-145 of the swarm 105 maintain and share an example distributed database 250, which may be an example blockchain-based database (BDB) 250. The distributed database 250 stores inventory data, failure statistics, pre-trained AI models, recipes, etc., associated with the device swarm 105. In some examples, the distributed database 250 is initialized with a minimum of two nodes. In some examples, interaction with the distributed database 250 is limited to valid onboarded compute devices 225-245 that are part of the swarm 105 and ends when a given device is no longer onboarded or has left the swarm 105. In some examples, the incorporation of new knowledge (e.g., inventory data, failure statistics, pre-trained AI models, recipes, etc.) into the distributed database 250 involves weighted voting from the participant nodes in the swarm 105. In some examples, a given node's weight is based on the similarity between the requester's inventory details and the given node's inventory details. Thus, nodes similar to the requesting node have more authority to accept or deny a request to add knowledge to the database than nodes dissimilar to the requesting node. In some examples, when no similar nodes are present, the requested knowledge is incorporated into the distributed database 250 because it is considered the first knowledge of its type.

In some examples, an onboarded compute device, such as the compute device 125, under ACM or similar device management, can join only one swarm, such as the swarm 105. In some examples, the SRCA engine 150 of the compute device 125 autonomously chooses which swarm to join based on network reachability and similarity with the connected device(s) already included in the swarm. Thus, the SRCA engine 150 of the compute device 125 pursues a natural grouping of knowledge (e.g., inventory data, failure statistics, pre-trained AI models, recipes, etc.) per device type to address common concerns, risks, and associated root causes of operational anomalies. In some examples, the SRCA engine 150 of the compute device 125 will cause the compute device 125 join a device swarm regardless of device similarity when there is only one swarm available. However, a new swarm may emerge from an existing one following a split procedure based on device similarity and the numbers of devices in each split swarm, as disclosed in further detail below.

In some examples, two compute devices can belong to different swarms based on their respective similarities to the different swarms even if the compute devices are geographically collocated and/or on the same network. Thus, in some examples, swarms are logical groupings rather than physical groupings. However, although a compute device may join just one swarm, compute devices may communicate across swarms to obtain knowledge (e.g., recipes) that is not available in their resident swarms. In some such examples, compute device(s) in one swarm, such as the compute device 125 in swarm 105, operate in an ambassador role in front of compute device(s) from other swarms. For example, the compute device 125 in the swarm 105 may attend to a request from a compute device in the swarm 110 to look for recipes for a given risk when no local recipe exists in the swarm 110. Also, such communications can be conveyed by the OOB communication interfaces of the different compute devices, without reliance on connectivity with a public or private cloud.

As described above, the swarm-based root cause analysis architecture is based on the following two families of components in the compute device 125: (i) the components embedded the firmware 245 and/or circuitry 205-220 of the SRCA engine 150 and that run independently of access to the OS 255 of the compute device 125, and (ii) the components included in the optional SRCA agent 155 and that runs on top of the OS 255 to enhance the root cause analysis capabilities of the compute device 125. The components of the SRCA engine 150 include the swarm manager circuitry 205, the knowledge manager circuitry 210, the anomaly detector circuitry 215 and the path analyzer circuitry 220.

The knowledge manager circuitry 210 of the illustrated example manages the access, creation, reading, writing, voting, etc., associated with the distributed database 250, as described above. For example, the knowledge manager circuitry 210 cooperates with knowledge manager circuitry included in the other compute devices 130-145 of the swarm 105 to implement the distributed database. As described above, the knowledge manager circuitry 210 may implement blockchain features to add information to the distributed database, govern access to information in the database, validate information accessed from the database, etc. Additionally or alternatively, the knowledge manager circuitry 210 may generate and/or respond to requests to add knowledge to the distributed database 250 and implement weighted voting to determine whether such requests are to be granted or denied. Additionally or alternatively, the knowledge manager circuitry 210 may store and maintain a local copy of the distributed database 250 that contains public information that can be communicated from the compute device 125 to other compute devices 130-145 in the swarm 105, as well as private information whose access is restricted to the compute device 125.

The anomaly detector circuitry 215 of the illustrated example implements an AI model to detect anomalous operation, referred to as anomalies, associated with the compute device 125. In some examples, the AI model of the anomaly detector circuitry 215 is a pre-trained, or pre-calibrated, auto-encoder model that is quantized to fit in the hardware resources of the SRCA engine 150. In some examples, the AI model of the anomaly detector circuitry 215 can be updated with a firmware update, obtained from the distributed database 250, re-trained/updated by the compute devices 125-145 of the swarm 105, or any combination thereof. In some examples, the AI model of the anomaly detector circuitry 215 is designed to operate in a multivariate environment in which various metrics monitored by the compute device 135 represent the autoencoder input, and the output of the AI model is an anomaly probability. The anomaly probability may represent a likelihood of the compute device 125 experiencing an actual anomaly or a potential anomaly in the future.

In some examples, the AI model (e.g., the autoencoder model) implemented by the anomaly detector circuitry 215 takes as inputs (e.g., when available) any or all of the following device metrics collected, generated or otherwise obtained by the compute device 125:
Battery Metrics: which may include charge rates, current, voltage, etc.
Circuit, Outlet, Power Distribution Metrics: current, voltage, power, energy, frequency, etc.
Coolant Connector, Cooling Loop Metrics: which may include pressure, flow rate, temperature, etc.
Drive Metrics: which may include read/write counters, uncorrectable error counts, power, temperature, corrected errors, memory statistics, etc.
Environment Metrics: which may include power, energy, temperature, humidity, etc.
Heater Metrics: which may include heating time, power, temperature, etc.
Memory Metrics: which may include read/write counters, uncorrectable error counts, power, temperature, corrected error counters, predicted media life, etc.
Network Adapter Metrics: which may include transmit (TX0 and/or receive (RX) counters, counters for network connectivity status indicator(s), multicast and/or unicast TX and/or RX metrics, etc.
Network Device Function Metrics: which may include TX and/or RX counters, counters for fiber channels, multicast and/or unicast TX and/or RX metrics, etc.
Port Metrics: which may include TX and/or RX counters, counters for fiber channels, transceivers, multicast and/or unicast TX and/or RX metrics, etc.
Power Supply Metrics: which may include input and/or output current, voltage, power, energy, frequency, etc.
Processor Metrics: which may include TX and/or RX counters, counters for network connectivity status indicator(s), multicast and/or unicast TX and/or RX metrics, etc.,
Pump Metrics: which may include speed, speed control, etc.
Reservoir Metrics: which may include fluid level, pressure, etc.
Sensor Metrics: which may include sensor read metrics, sensor power/energy metrics, average, lowest, and/or peak sensor reading, etc.
Storage Controller Metrics: which may include read/write bytes and units, uncorrected error counts, memory properties, correctable error counts etc.
Thermal Metrics: which may include power, energy, temperature readings, heater usage, lifetime readings, etc.

As described above and in further detail below, the output of the anomaly detector circuitry 215 may act as a trigger to initiate further root cause analysis, such as root cause path analysis to predict a potential future device state of the compute device 125 that may be associated with an anomaly before that anomaly materializes. For example, the output of the anomaly detector circuitry 215 may trigger operation of the path analyzer circuitry 220 if the output of the anomaly detector circuitry 215 satisfies a threshold representative of an actual or predicted anomaly being detected.

The path analyzer circuitry 220 of the illustrated example uses an embedded graph approach to track the operational state of the compute device 125 using logged data and/or other metrics. In some examples, the path analyzer circuitry 220 generates the graph during an initial operating period/duration of the compute device 125. For example, during the initial operating period/duration, the path analyzer circuitry 220 may evaluate logged data and/or other metrics generated by the compute device 125 to identify operating states of the compute device 125 and the transitions between those states, and populate a graph based on that information. In some examples, after the graph is generated, the path analyzer circuitry 220 waits to be triggered by the anomaly detector circuitry 215, thereby conserving device resources until an actual or potential anomaly is detected. In some examples, once triggered, the path analyzer circuitry 220 of the illustrated example traverses the graph using the logged data and/or other metrics generated within a time window of the trigger event to identify the current device state of the compute device 125.

In some examples, the path analyzer circuitry 220 also predicts a next device state of the compute device 125 based on the current device state identified via traversal of the embedded graph. In some examples, the path analyzer circuitry 220 implements an AI model trained to predict a next device state based on a current device state. In some examples, the AI model predicts the next device state based on the current device state and logged data and/or other device metrics (e.g., within the same time window or a different time window relative to the logged data and/or metrics used to traverse the embedded graph). In some examples, the AI model of the path analyzer circuitry 220 is quantized to fit in the hardware resources of the SRCA engine 150. In some examples, the AI model of the path analyzer circuitry 220 can be updated with a firmware update, obtained from the distributed database 250, re-trained/updated by the compute devices 125-145 of the swarm 105, or any combination thereof. In some examples, the AI model of the path analyzer circuitry 220 is different from the AI model of the anomaly detector circuitry 215.

In some examples, the path analyzer circuitry 220 invokes the knowledge manager circuitry 210 to query the distributed database 250 maintained by the device swarm 105 for one or more recipes to identify a root cause associated with the predicted next device state of the compute device 125. In some examples, the knowledge manager circuitry 210 may query a local copy of the database 250 maintained by the knowledge manager circuitry 210 and/or query one or more copies of the database 250 maintained by other ones of the compute devices 130-145 in the device swarm 105. In some examples, the query includes the predicted next device state of the compute device 125 and inventory data of the compute device 125. As such, the query can return one or more recipes associated with the likely next state and the device characteristics of the compute device 125. Such recipe(s) can include instructions tailored to the device characteristics of the compute device 125 and intended to mitigate a root cause associated with operation of the compute device 125 in the predicted next device state, and/or intended to cause the compute device 125 to avoid transitioning to that predicted next device state. For example, such instructions can include (i) instructions to modify operation of the compute device 125 (e.g., by activating dormant processor cores, deactivating processor cores, migrating workloads among processor cores, changing/reducing clock frequency, increasing or decreasing supply voltage, etc.) to counteract aging effects that are likely to be the root cause of the transition to the predicted next device state, (ii) instructions to modify the environment of the compute device 125 (e.g., by reducing enclosure temperature, reducing enclosure humidity, etc.) to counteract environmental effects that are likely to be the root cause of the transition to the predicted next device state, (iii) instructions to rollback a software/firmware update applied to the compute device 125 and/or to install a new software/firmware update or patch to counteract a software/firmware that is likely to be the root cause of the transition to the predicted next device state, etc. In some examples, the instructions provided in the recipe(s) can cause the compute device 125 to perform a cold start and/or any other auto-recovery procedure, followed by downloading one or more AI model(s) from the distributed database 250 to re-initialize swarm-based root cause analysis at the compute device 125. In some examples, if the query of the distributed database 250 maintained by the device swarm 105 is unsuccessful (e.g., does not return a recipe meeting the query criteria), the knowledge manager circuitry 210 may query other compute device(s) that act as ambassadors (also referred to as ambassador devices, agents, liaison devices, intermediate devices, etc.), for one or more of the other swarm(s) 110-120 to attempt to obtain recipe(s) for root cause analysis, as described above.

The swarm manager circuitry 205 of the illustrated example is responsible for causing the compute device 125 to join a device swarm, such as the swarm 105, based on characteristics of the compute device 125. In some examples, to join a device swarm, such as the device swarm 105, the swarm manager circuitry 205 utilizes the OOB communication interface of the SRCA engine 150 to communicate with a compute device, such as the compute device 130, that is acting as an ambassador for the device swarm 105. In some such examples, the swarm manager circuitry 205 queries the ambassador compute device 130 for inventory data maintained in the distributed database for the member devices of the swarm 105. The swarm manager circuitry 205 then performs a similarity computation to compare the device inventory of the compute device 125 to the device inventories obtained from the ambassador compute device 130 for the member devices of the swarm 105. Based on a result of this similarity computation, the swarm manager circuitry 205 decides whether to cause the compute device 125 to join the device swarm 105. For example, the device inventories may specify one or more compute device characteristics, such as processor cores, memories, components, operating specifications, etc., and the similarity computation may output a value, or score, representative of the similarity between two device inventories. In some such examples, the swarm manager circuitry 205 decides whether to cause the compute device 125 to join the device swarm 105 based on whether the similarity computation satisfies a threshold.

The swarm manager circuitry 205 of the illustrated example is also responsible for managing swarm membership the device swarm 105 after the compute device 125 joins the device swarm 105, which may include splitting the swarm 105 into multiple swarms as membership evolves to yield device swarms having closely aligned device characteristics. In some examples, the swarm manager circuitry 205 decides whether to split the device swarm 105 based on a density-based clustering algorithm, such as Density-Based Spatial Clustering of Applications with Noise (DBSCAN). In some examples, the swarm manager circuitry 205 additionally or alternatively decides whether to split the device swarm 105 based on a target number of devices per device swarm. In some examples, the swarm manager circuitry 205 additionally or alternatively decides whether to split the device swarm 105 based on a pre-defined and/or configurable update frequency (e.g., hourly, daily, etc.).

As described above, the components included in the optional SRCA agent 155 run on top of the OS 255 to enhance the root cause analysis capabilities of the compute device 125. In some examples, the SRCA agent 155 is installed on the compute device 125 and accesses host-based resources. In some examples, the SRCA agent 155 is detected, managed, and tracked by the SRCA engine 150 after being installed on the compute device 125. The components of the SRCA agent 155 include the AI model manager circuitry 225, the action scheduler circuitry 230, the vector cache manager circuitry 235 and the RAG manager circuitry 240.

The AI model manager circuitry 225 of the illustrated example manages the AI model(s) used by the SRCA engine 150 for anomaly detection, path analysis and next state prediction, etc. In some examples, during system initialization and/or cold start scenarios, the AI model manager circuitry 225 can identify the appropriate versions of the AI model(s) to be downloaded from the distributed database 250 (e.g., by the knowledge manager circuitry 210). In some examples, the AI model manager circuitry 225 updates (e.g., retrains) one or more of the AI models in a distributed manner using local data, statistics from the distributed database 250, information obtained by the RAG manager circuitry 240, etc., and provides its results to another compute device managing the AI model retraining. In some such examples, the AI model manager circuitry 225 does not exchange local data externally but limits the exchanged data to the updated AI model weights to preserve data sovereignty. In some examples, the AI model manager circuitry 225 triggers a distributed update (e.g., retraining) of one or more of the AI models and merges the results from other compute devices to generate the updated AI models. In some examples, operation of the AI model manager circuitry 225 is triggered by the action scheduler circuitry 230.

The RAG manager circuitry 240 of the illustrated example collects and enriches contextual data at the compute device 125 using logged data, device metrics, the current device state, etc., determined at the compute device 125. In some examples, the RAG manager circuitry 240 provides the enriched contextual data to the AI model manager circuitry 225 for use in AI model management and retraining.

The vector cache manager circuitry 235 of the illustrated example manages local tokenization and data management to optimize local data representation at the compute device 125. For example, the vector cache manager circuitry 235 converts logged data, device metrics, etc., generated at the compute device to tokens that can be stored as vectors and shared among other compute devices 130-145 in the device swarm 105. Such tokenization helps ensure that devices with different characteristics can share data (e.g., inventory data, statistics, AI models, etc.) in a common format understandable within the device swarm 105. In some examples, the vector cache manager circuitry 235 provides tokenized data to the RAG manager circuitry 240 feeds RAGM, provides tokenized data to the knowledge manager circuitry 210 to be used for queries of the distributed database 250, etc.

The action scheduler circuitry 230 triggers and/or otherwise schedules operation of the AI model manager circuitry 225 to manage and/perform collaborative AI model training and model updates for one or more of the AI models available in the swarm 105. In some examples, the action scheduler circuitry 230 triggers and/or otherwise schedules the AI model manager circuitry 225 to manage, or govern, collaborative training, also referred to as distributed training, of an AI model by one or more of the other compute devices 130-145 of the device swarm 105. For example, the action scheduler circuitry 230 may trigger the AI model manager circuitry 225 to initiate the training of a given AI model, the collection and consolidation of the training results provided by the compute devices, and the storage of the AI model (e.g., the model weights and/or other metadata) in the distributed database 250 to make the new version of the AI model available to the compute devices 125-145 in the swarm 105. In some examples, the AI model manager circuitry 225 may also cause one or more notifications to be sent to the compute devices 125-145 to indicate the new version of the AI model is available.

In some examples, the action scheduler circuitry 230 additionally or alternatively triggers and/or otherwise schedules operation of the AI model manager circuitry 225 to act as one of the compute devices that performs the collaborative/distributed training of an AI model locally, as described above. For example, the action scheduler circuitry 230 may respond to another compute device initiating the collaborative/distributed training of an AI model by the triggering and/or otherwise scheduling the AI model manager circuitry 225 to train the AI model locally and report the training results to the compute device managing/governing the model training. In some examples, the action scheduler circuitry 230 may trigger and/or otherwise schedule operation of the AI model manager circuitry 225 to act as both a governor and a worker in the collaborative/distributed training of a given AI model.

In some examples, the action scheduler circuitry 230 may trigger and/or otherwise schedule operation of other components of the SRCA agent 155 and/or the SRCA engine 150. For example, the swarm manager circuitry 205, the knowledge manager circuitry 210, the anomaly detector circuitry 215 and/or the path analyzer circuitry 220 of the SRCA engine 150 may operate under a default schedule when the SRCA agent 155 is not detected as installed at the compute device 125. However, when the SRCA agent 155 is installed an active at the compute device 125, the action scheduler circuitry 230 may trigger and/or otherwise revise the operation schedule of the swarm manager circuitry 205, the knowledge manager circuitry 210, the anomaly detector circuitry 215 and/or the path analyzer circuitry 220 based on the current operating state of the compute device 125 to reduce/optimize resource usage, meet target root cause analysis timeframes, etc.

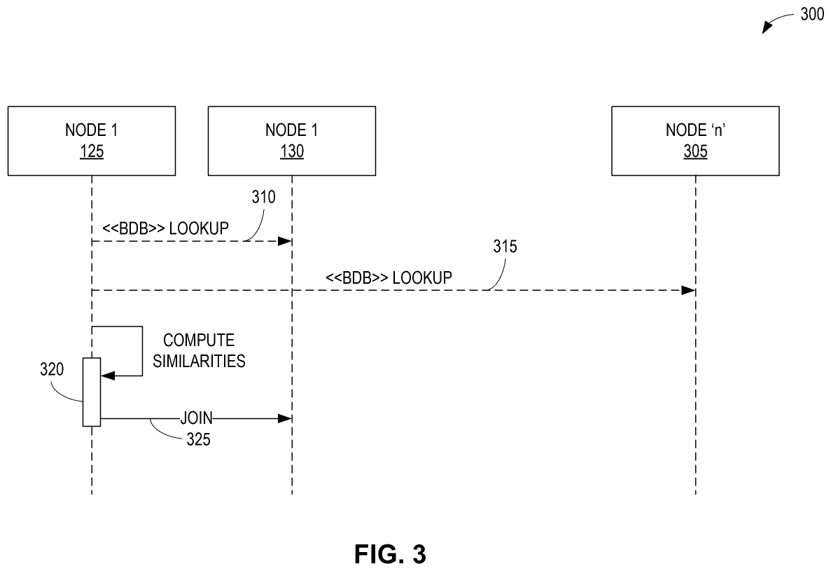

FIG. 3 is a sequence diagram illustrating an example joining procedure 300 to be performed by the compute device 125 of FIG. 2 to join a swarm of compute devices, such as the swarm 105. In the illustrated example of FIG. 3, the compute device 125 (labelled as “Node 1” in FIG. 3) performs the joining procedure 300 in combination with the compute device 130 (labelled as “Node 2” in FIG. 3), which is included in the device swarm 105, and another example compute device 305 (labelled as “Node n” in FIG. 3), which is included in another device swarm, such as the swarm 110. The joining procedure 300 is an autonomous procedure performed by the compute device 125 to join a device swarm that supports root cause analysis through the sharing of knowledge via a distributed database, such as the distributed database 250. In some examples, the compute device 125 performs the joining procedure 300 to initially join a device swarm when the compute device 125 has not yet joined a swarm, join a new device swarm after the compute device 125 has already joined a device swarm, rejoin a device swarm, etc. The joining procedure 300 of the illustrated example assumes the compute devices 125, 130 and 305 have already been onboarded such that the compute devices 125, 130 and 305 are operating in a OOB managed mode, such as the ACM of Intel's® AMT solution.

The joining procedure 300 of the illustrated example begins with the SRCA engine 150 and, more specifically, the swarm manager circuitry 205 of the compute device 125 detecting the presence of the compute device 125 (e.g., through any appropriate detection mechanism) and sending an example request 310 (e.g., represented as a distributed database lookup message 310 or BDB lookup message 310) to the compute device 130 for inventory data associated with itself and/or the swarm 105. In the illustrated example, the compute device 130 collects the inventory data from the distributed database 250 of the swarm 105 (e.g., from the copy maintained at the compute device 130 and/or from one or more of the copies maintained at other compute devices 130-145 of the swarm 105), and returns the collected inventory data to the swarm manager circuitry 205 of the compute device 125.

Similarly, the SRCA engine 150 and, more specifically, the swarm manager circuitry 205 of the compute device 125 detects the presence of the compute device 305 (e.g., through any appropriate detection mechanism) and sends an example request 315 (e.g., represented as a distributed database lookup message 315 or BDB lookup message 315) to the compute device 305 for inventory data associated with itself and/or the swarm 110. In the illustrated example, the compute device 305 collects the inventory data from the distributed database of the swarm 110 (e.g., from the copy maintained at the compute device 305 and/or from one or more of the copies maintained at other compute devices of the swarm 110), and returns the collected inventory data to the swarm manager circuitry 205 of the compute device 125.

The swarm manager circuitry 205 of the compute device 125 then performs an example similarity computation 320 based on the inventory data obtained for the device swarm 105 and the device swarm 110 to determine which swarm to join. For example, the output of the similarity computation 320 may be a first similarity score representative of the similarity between the compute device 125 and the swarm 105, and a second similarity score representative of the similarity between the compute device 125 and the swarm 110. In some such examples, the swarm manager circuitry 205 decides to join the swarm having the best (e.g., largest) similarity score. For example, in the joining procedure 300 of FIG. 3, the swarm manager circuitry 205 decides to join the device swarm 105 as a result of the similarity computation 320. Therefore, the swarm manager circuitry 205 of the compute device 125 sends an example join message 325 to the compute device 130 to join the swarm 105. For example, the join message 325 may include inventor details for the compute device 125, which the compute device 130 adds to the distributed database 250 of the swarm 105.

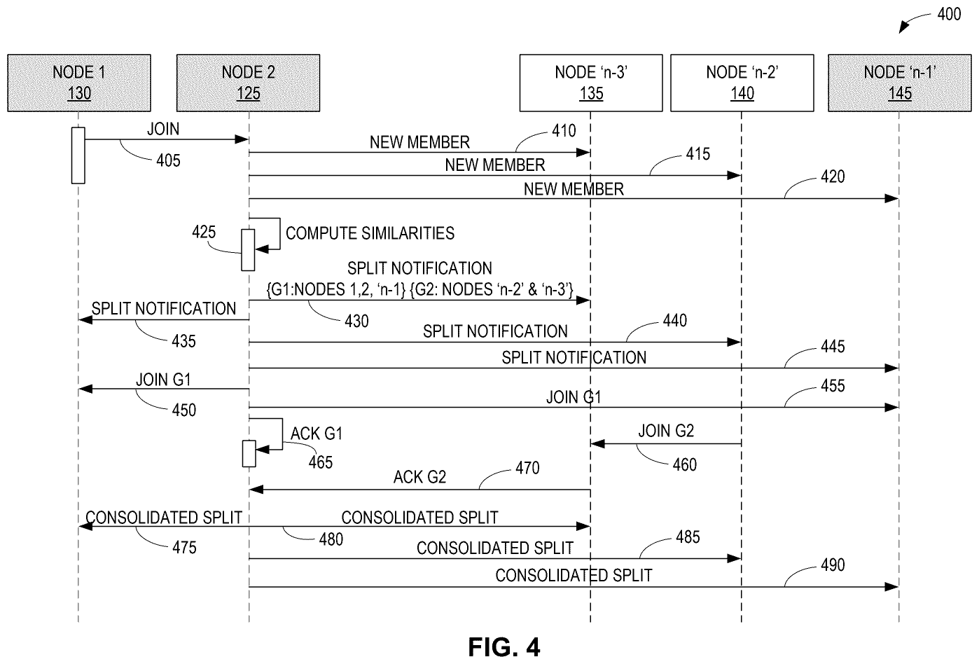

FIG. 4 is a sequence diagram illustrating an example splitting procedure 400 performed by the compute device 125 of FIG. 2 to cause an existing swarm of compute devices, such as the swarm 105, to be split into multiple swarms of compute devices. In the illustrated example of FIG. 4, the compute device 125 (labelled as “Node 2” in FIG. 4) performs the splitting procedure 400 in combination with the other compute devices 130-145 (labelled as “Node 1,” “Node n−3,” “Node n−2,” and “Node n−1,” respectively, in FIG. 4) included in the device swarm 105. The splitting procedure 400 is an autonomous procedure performed by the compute device 125 to split a device swarm, such as the device swarm 105, into multiple swarms including respective subsets of the compute devices 125-145 that have more closely aligned device characteristics.

The splitting procedure 400 of the illustrated example begins with the SRCA engine 150 and, more specifically, the swarm manager circuitry 205 of the compute device 125 receiving an example join message 405 from the compute device 130, which indicates the compute device 130 has joined the swarm 105. When the compute device 130 joins the swarm 105, the new member's information (e.g., inventor details) is updated in the distributed database 250 by the swarm manager circuitry 205 of the compute device 125. The swarm manager circuitry 205 of the compute device 125 also causes example notification messages 410-420 to be sent to the compute devices 135-145 of the device swarm 105.

Next, the swarm manager circuitry 205 performs an example similarity computation 425 based on the device inventories of the compute devices 125-145 of the device swarm 105 to review the group compositions. For example, the swarm manager circuitry 205 may use DBSCAN to perform any of the similarity computations disclosed herein, including the similarity computation 425. In some examples, the similarity computation 425 indicates how similar, or cohesive, the inventory features of the different compute devices 125-145 are with each other. In some examples, to perform any of the similarity computations disclosed herein, including the similarity computation 425, the swarm manager circuitry 205 converts the features in the device inventory for a given device into an n-dimensional vector (where the dimension is associated with the number of features), and the distance between vectors provides the similarity score for comparing two devices. In some examples, the swarm manager circuitry 205 employs tolerance parameter that it compares to the similarity scores from the similarity computation 425 to determine whether the swarm 105 should be split.

In the illustrated example splitting procedure 400 of FIG. 4, the swarm manager circuitry 205 of the compute device 125 decides to trigger a split of the swarm 105 based on the similarity computation 425. As a result, the swarm manager circuitry 205 of the compute device 125 causes example split notifications 430-445 to be sent to the current members of the swarm 105. In the illustrated examples, the split notifications 430-445 indicate the swarm 105 is to be split into two new swarms, with the first swarm including the compute device 125, 130 and 145 (represented as Group 1 with Nodes 1, 2, and ‘n−1’ in FIG. 4) and the second swarm including the compute devices 135 and 140 (represented as Group 2 with Nodes ‘n−2’ and ‘n−3’ in FIG. 4). As a result of the split notifications 430-445, the swarm manager circuitry 205 of the compute device 125 causes example join requests 450-455 to be sent to the compute devices 130 and 145 to form a first swarm corresponding to Group 1. In some examples, the knowledge manager circuitry 210 of the compute device 125 creates a new distributed database for the first swarm by retrieving the data from the distributed database 250 of the swarm 105 that is related to the members of this new swarm (e.g., the compute devices 125, 130 and 145) and omitting the data related to the other members of the original swarm 105 (e.g., the compute devices 135 and 140). In the illustrated example, the compute device 140 likewise sends an example join request 460 to the compute device 135 to form a second swarm corresponding to Group 2. In some examples, the compute device 140 also creates a new distributed database for the second swarm by retrieving the data from the distributed database 250 of the swarm 105 that is related to the members of this new swarm (e.g., the compute devices 135 and 140) and omitting the data related to the other members of the original swarm 105 (e.g., the compute devices 125, 130 and 145).

In the illustrated example splitting procedure 400 of FIG. 4, the swarm manager circuitry 205 of the compute device 125 processes example acknowledgments 465 and 470 indicating the formation of the new device swarms was successful. In response, the swarm manager circuitry 205 of the compute device 125 causes example consolidated split messages 475-490 to be sent the compute devices 130-145 to cause the old distributed database 250 corresponding to the swarm 105 to be removed. In some examples, if any portion of the splitting procedure 400 fails to complete (e.g., such as a timeout occurring while waiting for acknowledgement of the new swarm creation), the procedure 400 rolls back to the beginning and the original swarm 105 is retained.

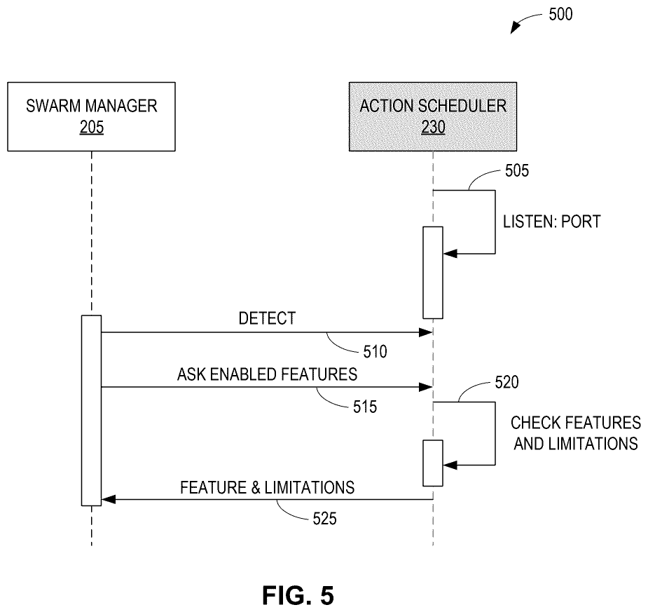

FIG. 5 is a sequence diagram illustrating an example activation procedure 500 performed by the compute device 125 of FIG. 2 to activate the SRCA agent 155. As described above, the SRCA agent 155 runs on top of the OS 255 when it is installed on the compute device 125, but installation of the SRCA agent 155 is not mandatory. For example, because the SRCA agent 155 consumes host resources of the compute device 125, a device user could decide whether to install the SRCA agent 155 based on expected device usage. When the SRCA agent 155 is installed, the SRCA agent 155 and, in particular, the action scheduler 230, listens for service requests through a port assigned during installation, which is represented by reference numeral 505 in the activation procedure 500. In the illustrated example activation procedure 500, the swarm manager circuitry 205 of the SRCA engine 150 detects installation of the SRCA agent 155, which is represented by reference numeral 510 in the activation procedure 500. The swarm manager circuitry 205 then sends an example feature request message 515 to the action scheduler 230, which causes the action scheduler 230 to check which features of the SRCA agent 155 have been enabled, which is represented by reference numeral 520 in the activation procedure 500. The action scheduler 230 then sends an example feature response message 525 to the swarm manager circuitry 205, which identifies the enabled features and any limitations that may be configured. In some examples, the swarm manager circuitry 205 uses this information to align a version of the firmware 245 implementing the SRCA engine 150 with a version of the SRCA agent 155.

In some examples, the device user can decide which features of the SRCA agent 155 to enable (e.g., such as whether model training is to be enabled, whether the distributed database 250 maintained at the compute device 125 can be accessed, copied, etc.) and under what limitations the features are to be enabled (e.g., a given feature may be permitted to be enabled if the compute device 125 is idle and for no more than ‘X’ hours per day). In some examples, the swarm manager circuitry 205 uses this information to know when to trigger a query and how to optimize it according to the limitations imposed by the user.

In some examples, the action scheduler 230 uses a Long Short-Term Memory (LSTM) model to estimate the usage of the compute device 125 based on local historical data. In some examples, the action scheduler 230 uses the LSTM to predict and/or update the expected resource availability of the compute device 125 at a particular time. For example, if the action scheduler 230 predicts an available time slot during which the compute device 125 is expected to be idle, the action scheduler 230 may trigger a genetic algorithm during that time slot to solve a non-linear optimization problem to identify further (e.g., “best”) time slots during which model training could be performed and collaborated training requests can be serviced.

One of the benefits from the collective swarm intelligence disclosed herein is in establishing a large enough sample size to identify statistically relevant conditions that could eventually lead to a negative impact on the SLA for given workloads. Improving the observed resiliency of the platform, as measured by SLA compliance, can be achieved by informing infrastructure and application orchestration components. For example, it is plausible that an environmental factor such as humidity and temperature, when combined with a certain level of CPU and memory utilization, may result in additional compounding performance and error rates. With these thresholds understood, either rate limiting or workload redistribution can be applied to prioritize SLA compliance over pure system performance.

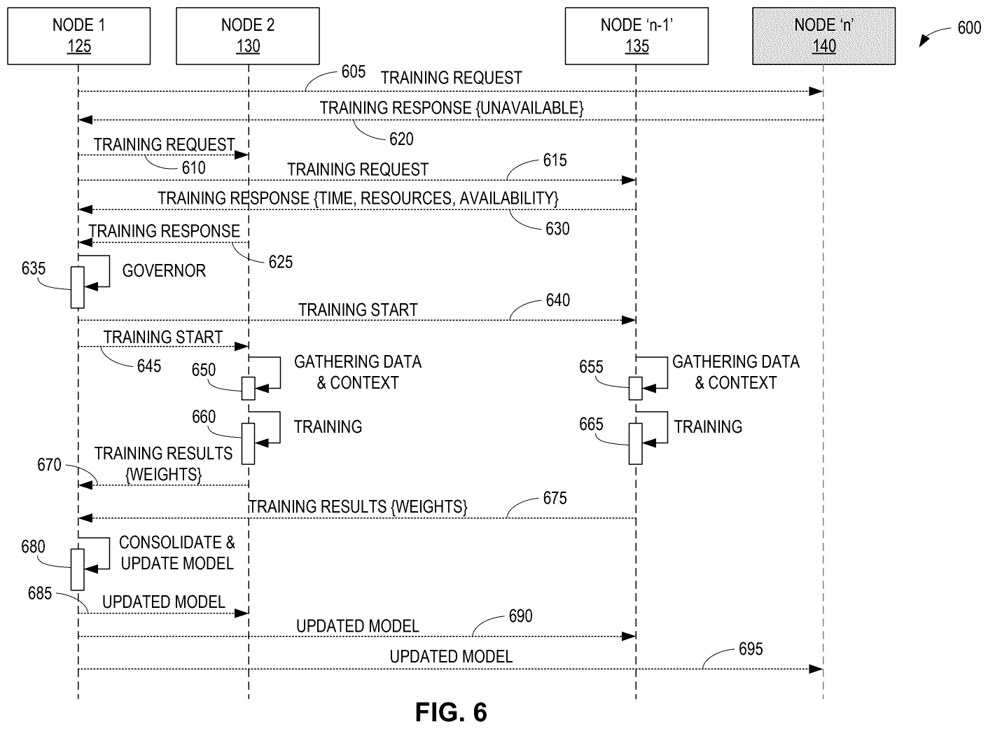

FIG. 6 is a sequence diagram illustrating an example model training procedure 600 performed by the compute device 125 of FIG. 2 to cause an example artificial intelligence model to be trained by a swarm of compute devices, such as the swarm 105. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of artificial intelligence models and/or machine learning architectures exist. In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Once training is complete, the model is deployed for use as an executable construct that processes an input and provides an output based on the network of nodes and connections defined in the model. In some examples, the model is stored in the distributed database of a swarm, such as the distributed database 250 of the swarm 105. The model may then be executed by the SRCA engine 150 to perform anomaly detection, device state prediction, etc.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Turning to the illustrated example of FIG. 6, AI model training depends on the availability of the SCRA agent 155 because the SCRA agent 155 is able to access sufficient host resources of the compute device 125 to accomplish model training. AI model training can also be constrained by the limitations and sharing policies specified by the device user. in some examples, any member of a swarm can initiate a training request to other members joined to the same swarm.

In some examples, a training request can have multiple possible responses, such as Available, Exceeded Timeout, or Unavailable. In an exceeded timeout situation, the swarm member is considered unavailable. However, the swarm member may respond that it is unavailable (for example, because it does not have available time slots for training). In some examples, the swarm member may responds that it is available and provide a set of available time slots and resources for performing model training.

In the model training procedure 600 of the illustrated example, the compute device 125 (represented as Node 1 in FIG. 6) acts as the initiator node or governor node to train an AI model in the swarm 105. The AI model manager 225 of the compute device 125 causes example training request messages 605-615 to be sent to other compute devices 130-140 (represented respectively as Nodes 2, ‘n−1 and ‘n’ in FIG. 6) included in the swarm 105. In the illustrated example model training procedure 600, AI model manager 225 of the compute device 125 receives corresponding example training response messages 620-630 that are responsive to the respective training request messages 605-615. The AI model manager 225 of the compute device 125, which is acting as the initiator/governor node for this AI model training procedure, analyzes the training response messages 620-630 to determine compute device availability and decide if there are sufficient device resources available to train the AI model (represented as reference numeral 635 in FIG. 6). If the AI model manager 225 of the compute device 125, which is acting as the initiator/governor node for this AI model training procedure, determines there are insufficient available resources to implement AI model training, the procedure 600 ends.

However, if the AI model manager 225 of the compute device 125, which is acting as the initiator/governor node for this AI model training procedure, determines there are sufficient available resources to implement AI model training, the AI model manager 225 of the compute device 125 governs this AI training instance. For example, the AI model manager 225 of the compute device 125 selects the compute device(s) to be included in the distributed training of the AI model. In the illustrated example, the AI model manager 225 of the compute device 125 selects the compute devices 130 and 135 to be included in the AI model training based on their respective responses 625 and 630. As a result, the AI model manager 225 of the compute device 125 causes example training start messages 640-645 to be sent to the compute devices 130 and 135 (which correspond to Nodes 2 and ‘n−1’ in FIG. 6).

In the illustrated example model training procedure 600, the AI model managers of the compute devices 130 and 135 respond to the training start messages 640-645 by gathering local data (e.g., device inventory, logs, etc.) and contextual information (e.g., error statistics, top k detected paths, applied actions, etc.) to be used for local training of the AI model at the compute devices 130 and 135 (represented by reference numerals 650 and 655 in FIG. 6). In some examples, the compute devices 130 and 135 do not share their training data. Next, the AI model managers of the compute devices 130 and 135 each train the AI model locally (represented by reference numerals 660 and 665 in FIG. 6). After local training completes, the AI model managers of the compute devices 130 and 135 cause example training result messages 670-675 to be sent to the AI model manager 225 of the compute device 125. In the illustrated example, the training result messages 670-675 include updated weights and/or other updated model parameters resulting from the local training at the respective compute devices 130 and 135.

In the illustrated example model training procedure 600, the AI model manager 225 of the compute device 125, which is acting as the governor node for this AI model training procedure, collects the training result messages 670-675, unifies the weights and/or other model parameters, and updates the AI model (which is represented by reference numeral 680 in FIG. 6). In some examples, updating the AI model includes quantizing the unified weights and/or other model parameters to fit in the resources of the SRCA engine 150. After the AI model is updated, the AI model manager 225 of the compute device 125, which is acting as the governor node for this AI model training procedure, causes example updated model messages 685-695 to be sent to the members of the swarm 105 (e.g., including those members not involved in this training instance) to cause the updated AI model to be stored in the copies of the distributed database 250 maintain at those swarm members.

Once the training is done, a different swarm member (e.g., such as compute device 130 corresponding to Node 2 of FIG. 6) may initiate another AI training instance for which it would become the governor for that training instance. This procedure repeats over time among the swarm members with installed SCRA agents enabled and based on any user constraints. Changes in compute resource availability over time (e.g., due to a user changing limitations of memory or processor availability) may affect the training frequency and are monitored between the action scheduler 230 and the swarm manager 205.

The foregoing example model training procedure 600 can be used to train any AI model stored in the distributed database 250 of the swarm 105 and/or employed by the SRCA engines and/or the SRCA agents of the compute devices 125-145 included in the swarm 105. For example, the model training procedure 600 can be used to train the AI model (e.g., the autoencoder model) of the anomaly detector circuitry 215, the AI model of the path analyzer circuitry 220, etc.

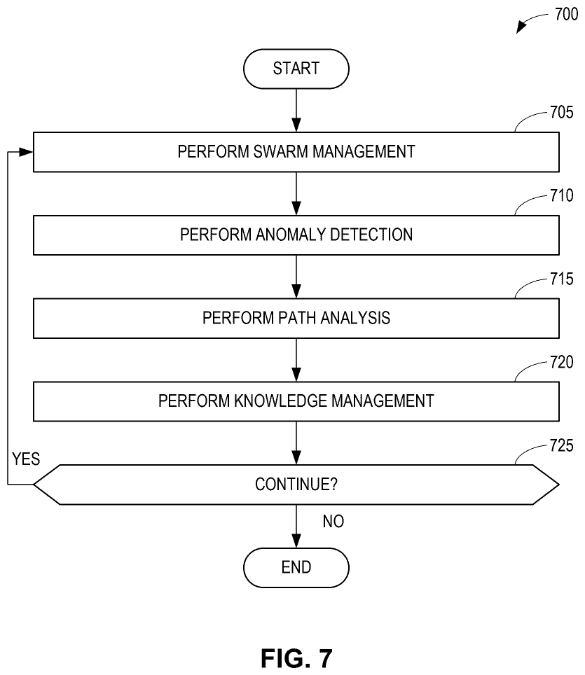

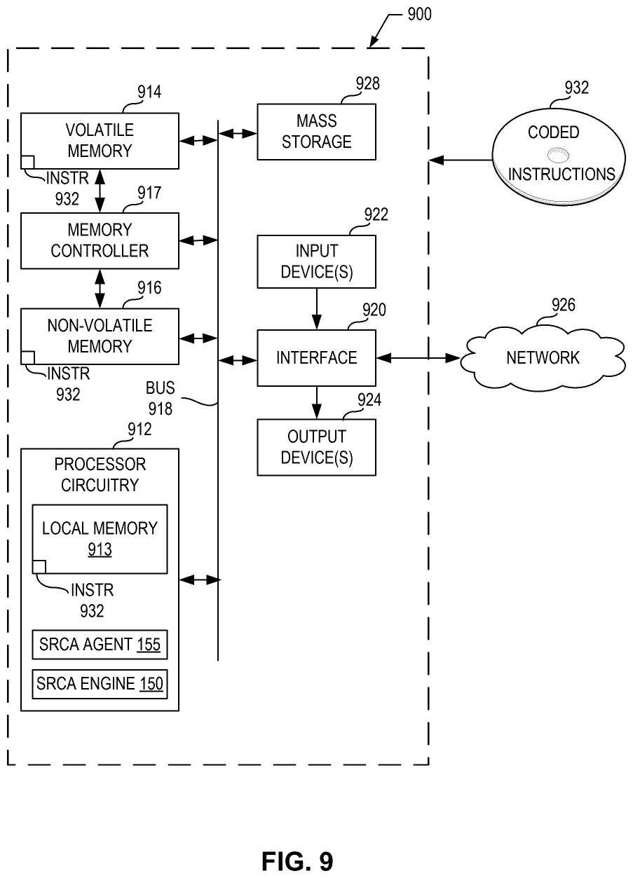

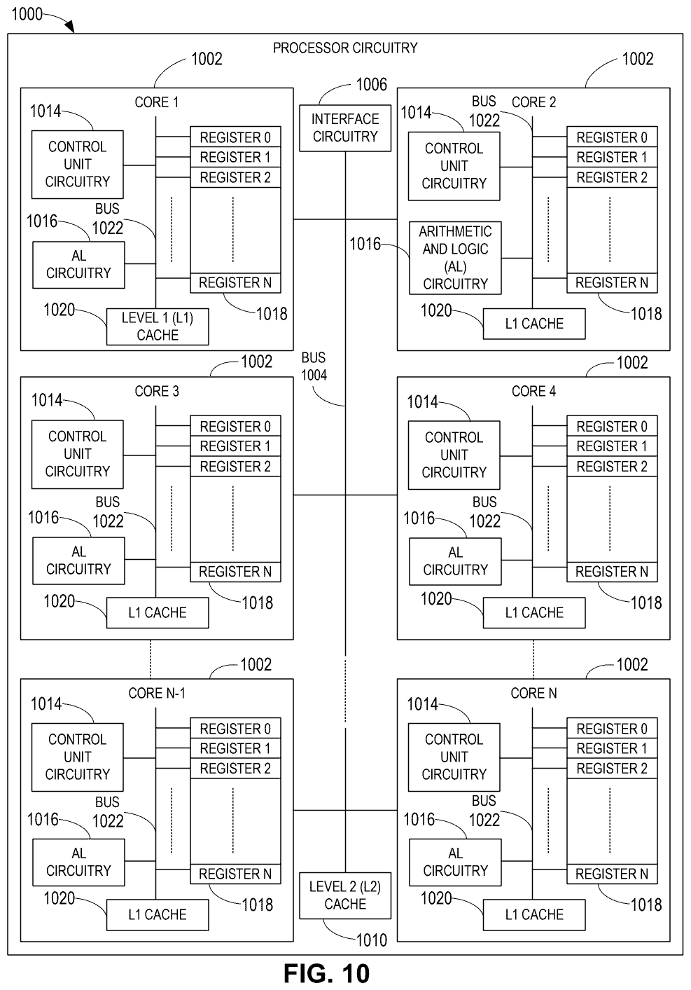

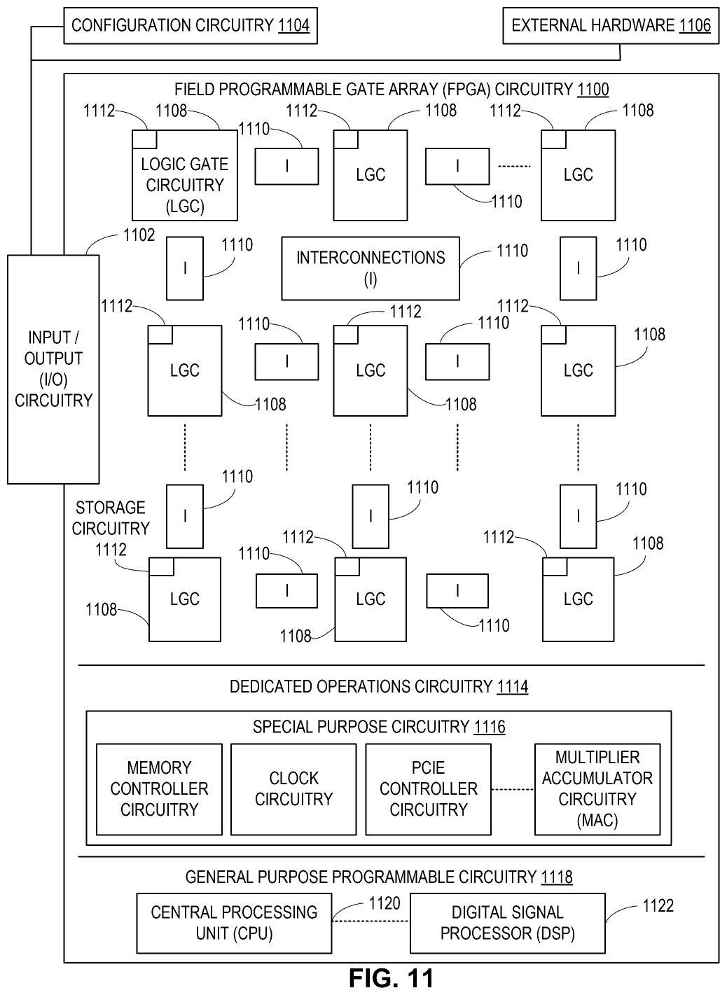

In some examples, the SRCA engine 150 includes means for performing swarm management. For example, the means for performing swarm management may be implemented by the swarm manager circuitry 205. In some examples, the swarm manager circuitry 205 may be instantiated by programmable circuitry such as the example programmable circuitry 912 of FIG. 9. For instance, the swarm manager circuitry 205 may be instantiated by the example microprocessor 1000 of FIG. 10 executing machine executable instructions such as those implemented by at least the operations of FIGS. 3 and/or 4, and/or block 705 of FIG. 7. In some examples, the swarm manager circuitry 205 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the swarm manager circuitry 205 may be instantiated by any other combination of hardware, software, and/or firmware. For example, the swarm manager circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the SRCA engine 150 includes means for performing knowledge management. For example, the means for performing knowledge management may be implemented by the knowledge manager circuitry 210. In some examples, the knowledge manager circuitry 210 may be instantiated by programmable circuitry such as the example programmable circuitry 912 of FIG. 9. For instance, the knowledge manager circuitry 210 may be instantiated by the example microprocessor 1000 of FIG. 10 executing machine executable instructions such as those implemented by at least block 720 of FIG. 7. In some examples, the knowledge manager circuitry 210 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the knowledge manager circuitry 210 may be instantiated by any other combination of hardware, software, and/or firmware. For example, the knowledge manager circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the SRCA engine 150 includes means for performing anomaly detection. For example, the means for performing anomaly detection may be implemented by the anomaly detector circuitry 215. In some examples, the anomaly detector circuitry 215 may be instantiated by programmable circuitry such as the example programmable circuitry 912 of FIG. 9. For instance, the anomaly detector circuitry 215 may be instantiated by the example microprocessor 1000 of FIG. 10 executing machine executable instructions such as those implemented by at least block 710 of FIG. 7. In some examples, the anomaly detector circuitry 215 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the anomaly detector circuitry 215 may be instantiated by any other combination of hardware, software, and/or firmware. For example, the anomaly detector circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the SRCA engine 150 includes means for performing path analysis. For example, the means for performing path analysis may be implemented by the anomaly detector circuitry 215. In some examples, the path analyzer circuitry 220 may be instantiated by programmable circuitry such as the example programmable circuitry 912 of FIG. 9. For instance, the path analyzer circuitry 220 may be instantiated by the example microprocessor 1000 of FIG. 10 executing machine executable instructions such as those implemented by at least block 715 of FIG. 7. In some examples, the path analyzer circuitry 220 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the path analyzer circuitry 220 may be instantiated by any other combination of hardware, software, and/or firmware. For example, the path analyzer circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

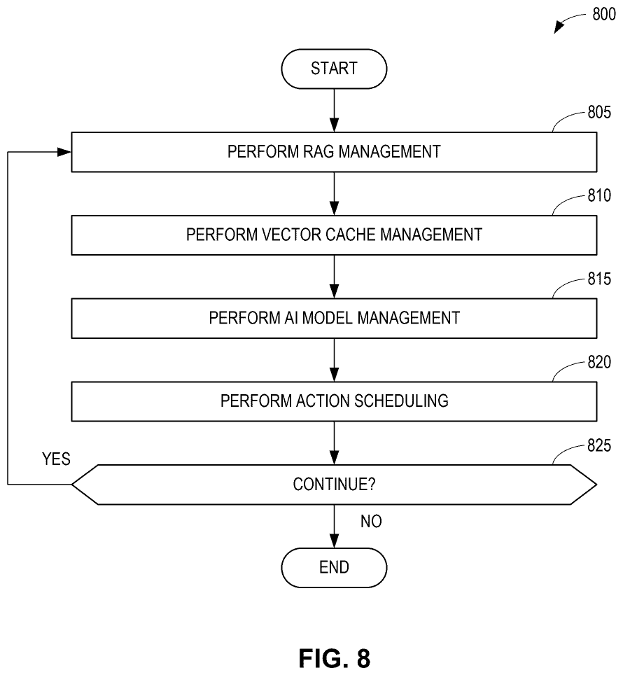

In some examples, the SRCA agent 155 includes means for performing AI model management. For example, the means for performing AI model management may be implemented by the AI model manager circuitry 225. In some examples, the AI model manager circuitry 225 may be instantiated by programmable circuitry such as the example programmable circuitry 912 of FIG. 9. For instance, the AI model manager circuitry 225 may be instantiated by the example microprocessor 1000 of FIG. 10 executing machine executable instructions such as those implemented by at least the operations of FIG. 6, and/or block 815 of FIG. 8. In some examples, the AI model manager circuitry 225 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the AI model manager circuitry 225 may be instantiated by any other combination of hardware, software, and/or firmware. For example, the AI model manager circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the SRCA agent 155 includes means for performing action scheduling. For example, the means for performing action scheduling may be implemented by the action scheduler circuitry 230. In some examples, the action scheduler circuitry 230 may be instantiated by programmable circuitry such as the example programmable circuitry 912 of FIG. 9. For instance, the action scheduler circuitry 230 may be instantiated by the example microprocessor 1000 of FIG. 10 executing machine executable instructions such as those implemented by at least block 820 of FIG. 8. In some examples, the action scheduler circuitry 230 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the action scheduler circuitry 230 may be instantiated by any other combination of hardware, software, and/or firmware. For example, the action scheduler circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the SRCA agent 155 includes means for performing vector cache management. For example, the means for performing vector cache management may be implemented by the vector cache manager circuitry 235. In some examples, the vector cache manager circuitry 235 may be instantiated by programmable circuitry such as the example programmable circuitry 912 of FIG. 9. For instance, the vector cache manager circuitry 235 may be instantiated by the example microprocessor 1000 of FIG. 10 executing machine executable instructions such as those implemented by at least block 810 of FIG. 8. In some examples, the vector cache manager circuitry 235 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the vector cache manager circuitry 235 may be instantiated by any other combination of hardware, software, and/or firmware. For example, the vector cache manager circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the SRCA agent 155 includes means for performing RAG management. For example, the means for performing RAG management may be implemented by the RAG manager circuitry 240. In some examples, the RAG manager circuitry 240 may be instantiated by programmable circuitry such as the example programmable circuitry 912 of FIG. 9. For instance, the RAG manager circuitry 240 may be instantiated by the example microprocessor 1000 of FIG. 10 executing machine executable instructions such as those implemented by at least block 805 of FIG. 8. In some examples, the RAG manager circuitry 240 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the RAG manager circuitry 240 may be instantiated by any other combination of hardware, software, and/or firmware. For example, the RAG manager circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the SRCA engine 150 and the SRCA agent 155 of FIG. 1 is illustrated in FIG. 2, one or more of the elements, processes, and/or devices illustrated in FIG. 2 may be combined, divided, re-arranged, omitted, eliminated, and/or implemented in any other way. Further, the example swarm manager circuitry 205, the example knowledge manager circuitry 210, the example anomaly detector circuitry 215, the example path analyzer circuitry 220, the example AI model manager circuitry 225, the example action scheduler circuitry 230, the example vector cache manager circuitry 235, the example RAG manager circuitry 240 and/or, more generally, the example SRCA engine 150 and/or the example SRCA agent 155 of FIG. 2, may be implemented by hardware alone or by hardware in combination with software and/or firmware. Thus, for example, any of the example swarm manager circuitry 205, the example knowledge manager circuitry 210, the example anomaly detector circuitry 215, the example path analyzer circuitry 220, the example AI model manager circuitry 225, the example action scheduler circuitry 230, the example vector cache manager circuitry 235, the example RAG manager circuitry 240, and/or, more generally, the example SRCA engine 150 and/or the example SRCA agent 155, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example SRCA engine 150 and/or the example SRCA agent 155 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the SRCA engine 150 and/or the SRCA agent 155 of FIG. 2 and/or representative of example operations which may be performed by programmable circuitry to implement and/or instantiate the SRCA engine 150 and/or the SRCA agent 155 of FIG. 2, are shown in FIGS. 7-8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-8, many other methods of implementing the example SRCA engine 150 and/or the SRCA agent 155 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 7-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to implement the SRCA engine 150 of FIGS. 1 and/or 2. The example machine-readable instructions and/or the example operations 700 of FIG. 7 begin at block 705, at which the swarm manager circuitry 205 of the SRCA engine 150 performs swarm management, as described above. At block 710, the anomaly detector circuitry 215 of the SRCA engine 150 performs anomaly detection, as described above. At block 715, the path analyzer circuitry 220 performs path analysis, as described above. At block 720, the knowledge manager circuitry 210 performs knowledge management associated with the distributed database 250, as described above. At block 725, the SRCA engine 150 determines whether root cause analysis is to continue. If root cause analysis is to continue, control returns to block 705 and blocks subsequent thereto. Otherwise, the example machine-readable instructions and/or the example operations 700 end.

FIG. 8 is a flowchart representative of example machine readable instructions and/or example operations 800 that may be executed, instantiated, and/or performed by programmable circuitry to implement the SRCA agent 155 of FIGS. 1 and/or 2. The example machine-readable instructions and/or the example operations 800 of FIG. 8 begin at block 805, at which the RAG manager 240 of the SRCA agent 155 performs RAG management, as described above. At block 810, the vector cache manager 235 of the SRCA agent 155 performs vector cache management, as described above. At block 815, the AI model manager 225 of the SRCA agent 155 performs AI model management, as described above. At block 820, the action scheduler 230 performs action scheduling, as described above. At block 825, the SRCA agent 155 determines whether root cause analysis is to continue. If root cause analysis is to continue, control returns to block 805 and blocks subsequent thereto. Otherwise, the example machine-readable instructions and/or the example operations 800 end.

FIG. 9 is a block diagram of an example programmable circuitry platform 900 structured to execute and/or instantiate the example machine-readable instructions and/or the example operations of FIGS. 7-8 to implement the SRCA engine 150 and/or the SRCA agent 155 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, VPUs, DSPs, and/or microcontrollers from any desired family or manufacturer. The programmable circuitry 912 may be implemented by one or more semiconductor based (e.g., silicon based) devices. In this example, the programmable circuitry 912 implements the example swarm manager circuitry 205, the example knowledge manager circuitry 210, the example anomaly detector circuitry 215, the example path analyzer circuitry 220, and/or, more generally, the example SRCA engine 150. In this example, the programmable circuitry 912 also implements the example AI model manager circuitry 225, the example action scheduler circuitry 230, the example vector cache manager circuitry 235, the example RAG manager circuitry 240, and/or, more generally, the example SRCA agent 155.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 7-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 7-8 to effectively instantiate the circuitry of FIG. 2 as logic circuits to perform operations corresponding to those machine readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 7-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-8. As such, the FPGA circuitry 1100 may be configured and/or structured to effectively instantiate some or all of the operations/functions corresponding to the machine readable instructions of the flowchart(s) of FIGS. 7-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 7-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 7-8, and/or an ASIC may be configured and/or structured to perform third operation(s)/function(s) corresponding to a third portion of the machine readable instructions represented by the flowcharts of FIGS. 7-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

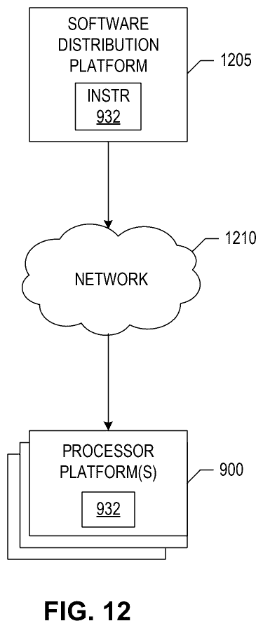

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIG. 7-8, may be downloaded to the example programmable circuitry platform 900, which is to execute the machine readable instructions 932 to implement the SRCA engine 150 and/or the SRCA agent 155. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement swarm techniques for root cause analysis. Disclosed systems, apparatus, articles of manufacture, and methods improve the efficiency of using a computing device by providing an example manageability engine that enables the compute device to discover and join a swarm of compute devices that share AI models, recipes, monitored logs, inventory information, etc., to facilitate autonomous anomaly detection, and root cause analysis and mitigation, without the need for centralized monitoring and control. Disclosed systems, apparatus, articles of manufacture, and methods also provide a root cause analysis agent that enables the compute device to cooperate with the swarm to collectively share and retrain one or more AI models used to perform anomaly detection, root cause path analysis, etc., resulting in AI models that are tailored to the specific characteristics of the compute devices in the swarm. Disclosed systems, apparatus, articles of manufacture, and methods are accordingly directed to one or more improvement(s) in the operation of one or more machine(s) such as a computer, and network of compute devices, or one or more other electronic and/or mechanical device(s).

Further examples and combinations thereof include the following. Example 1 includes a compute device comprising interface circuitry, machine-readable instructions, and at least one programmable circuit to be programmed based on the machine-readable instructions to access a swarm of compute devices, the swarm of compute devices to maintain a distributed database including an artificial intelligence model associated with anomaly detection, obtain the artificial intelligence model from the distributed database, and perform a root cause analysis based on the artificial intelligence model.

Example 2 includes the compute device of example 1, wherein the artificial intelligence model is a first artificial intelligence model, and one or more of the at least one programmable circuit is to perform the root cause analysis based on the first artificial intelligence model and a second artificial intelligence model obtained from the database, the second artificial intelligence model associated with prediction of a next device state based on a current device state.

Example 3 includes the compute device of example 2, wherein one or more of the at least one programmable circuit is to is to perform the root cause analysis by initiating a path analysis of a graph based on an output of the first artificial intelligence model to determine the current device state of the compute device, the graph representative of potential states and state transitions associated with the compute device, the path analysis based on logged data associated with the compute device, the output of the first artificial intelligence model based on one or more device metrics input to the first artificial intelligence model, the one or more device metrics associated with the compute device, and predicting the next device state of the compute device based on the current device state of the compute device and the second artificial intelligence model.

Example 4 includes the compute device of example 3, wherein to perform the root cause analysis, one or more of the at least one programmable circuit is to query the distributed database for a recipe to identify a root cause associated with the predicted next device state of the compute device, the query based on the predicted next device state of the compute device and a device inventory associated with the compute device.

Example 5 includes the compute device of example 3, wherein the swarm of compute devices is a first swarm of compute devices, and to perform the root cause analysis, one or more of the at least one programmable circuit is to cause communication with a second compute device included in a second swarm of compute devices to obtain a recipe after an unsuccessful query of the distributed database, the recipe to identify a root cause associated with the predicted next device state of the compute device.

Example 6 includes the compute device of example 4 or example 5, wherein one or more of the at least one programmable circuit is to cause the compute device to perform at least one of a cold start or an auto-recovery procedure based on the recipe, and download the artificial intelligence model from the distributed database.

Example 7 includes the compute device of any one of examples 1 to 4, wherein one or more of the at least one programmable circuit is to detect a second compute device has joined the swarm of compute devices, initiate a similarity computation based on detection of the second compute device, and cause the swarm of devices to split into a first swarm of compute devices and a second swarm of compute devices based on the similarity computation.

Example 8 includes the compute device of any one of examples 1 to 4, wherein to join the swarm of compute devices, one or more of the at least one programmable circuit is to cause communication with a second compute device in the swarm of compute devices, the communication to occur based on an out-of-band management service without use of an operating system of the compute device.

Example 9 includes the compute device of any one of examples 1 to 8, wherein one or more of the at least one programmable circuit is to cause communication of a request to ones of the compute devices in the swarm of compute devices to add first data from the compute device to the distributed database, and evaluate results of the request from the ones of the compute devices in the swarm of compute devices to determine whether the first data is permitted to be added to the distributed database.

Example 10 includes the compute device of example 9, wherein the results includes respective votes and weights from the ones of the compute devices in the swarm of compute devices, the weights based on similarity computations between the compute device and other ones of the compute devices in the swarm of compute devices.

Example 11 includes the compute device of example 9 or example 10, wherein the database is a distributed database based on a blockchain.

Example 12 includes the compute device of example 1, wherein the swarm of compute devices is a first swarm of compute devices, and one or more of the at least one programmable circuit is to access a communication from a second compute device included in a second swarm for a recipe to identify a root cause associated with a predicted next device state of the second compute device, query the distributed database for the recipe, and cause the recipe to be communicated to the second compute device.

Example 13 includes the compute device of example 1, wherein one or more of the at least one programmable circuit is to dynamically manage membership in the swarm based on at least one of a clustering algorithm, a target number of devices per device swarm, or an update frequency.

Example 14 includes the compute device of any one of examples 1 to 13, wherein the artificial intelligence model is an autoencoder model.

Example 15 includes the compute device of any one of examples 1 to 14, wherein one or more of the at least one programmable circuit is to cause communication of a training request to ones of the compute devices in the swarm of compute devices, the training request associated with training the artificial intelligence model, identify, based on responses to the training request, a subset of one or more of the compute devices to participate in the training of the artificial intelligence model, cause the subset of the compute devices to locally train the artificial intelligence model, and update the artificial intelligence model based on local training results from the subset of the compute devices.

Example 16 includes the compute device of any one of examples 1 to 4, wherein one or more of the at least one programmable circuit is to access a training request from a second compute device in the swarm of compute devices, the training request associated with training the artificial intelligence model, determine availability of the compute device to participate in the training of the artificial intelligence model, and cause communication of a response to the second compute device, the response based on the determined availability of the compute device.

Example 17 includes the compute device of example 16, wherein one or more of the at least one programmable circuit is to determine the availability of the compute device based on a long short-term memory model, the long short-term memory model trained to estimate device usage based on historical data.

Example 18 includes the compute device of example 16, wherein one or more of the at least one programmable circuit is to initiate local training of the artificial intelligence model based on a communication from a second compute device in the swarm of compute devices, and cause transmission of a result of the local training to the second compute device.

Example 19 includes at least one non-transitory machine-readable storage medium comprising instructions to cause at least programmable circuit of a compute device to at least cause the compute device to join a swarm of compute devices, access a distributed database shared among the swarm of compute devices, the distributed database including an artificial intelligence model and one or more recipes associated with root cause analyses to be performed by the swarm of compute devices, and perform at least one of the root cause analyses at the compute device based on the artificial intelligence model and the one or more recipes.

Example 20 includes the at least one non-transitory machine-readable storage medium of example 19, wherein to perform the at least one of the root cause analyses, the instructions are to cause one or more of the at least one programmable circuit to predict an anomaly occurrence based on the artificial intelligence model and one or more device metrics of the compute device, determine, based on the predicted anomaly occurrence, a current device state of the compute device, predict a next device state of the compute device, query the distributed database for a first one of the one or more recipes that identifies a root cause associated with the predicted next device state of the compute device, the query based on the predicted next device state of the compute device and a device inventory associated with the compute device, and cause performance of an action based on the first one of the one or more recipes.

Example 21 includes the at least one non-transitory machine-readable storage medium of example 19, wherein to perform the at least one of the root cause analyses, the instructions are to cause one or more of the at least one programmable circuit to detect a second compute device has joined the swarm of compute devices, initiate a similarity computation based on detection of the second compute device, the similarity computation based on device inventories of ones of the compute devices in the swarm of compute devices, and cause the swarm of devices to split into a first swarm of compute devices and a second swarm of compute devices based on the similarity computation.

Example 22 includes a compute device comprising means for forming a swarm of compute devices, and means for performing a root cause analysis based on an artificial intelligence model from a distributed database maintained by the swarm of compute devices.

Example 23 includes the compute device of example 22, wherein the means for forming is to detect a second compute device has joined the swarm of compute devices, initiate a similarity computation based on detection of the second compute device, the similarity computation based on device inventories of ones of the compute devices in the swarm of compute devices, and cause the swarm of devices to split into a first swarm of compute devices and a second swarm of compute devices based on the similarity computation.

Example 24 includes the compute device of example 22 or example 23, wherein the means for performing the root cause analysis is to predict an anomaly occurrence at the compute device based on the artificial intelligence model, determine, based on the predicted anomaly occurrence, a current device state of the compute device, query the distributed database for a first one of the one or more recipes that identifies a root cause associated with a predicted next device state of the compute device, the query based on the predicted next device state of the compute device and a device inventory associated with the compute device, and cause performance of an action based on the first one of the one or more recipes.

Example 25 includes a method for a compute device, the method comprising joining a swarm of compute devices, the swarm of compute devices to maintain a distributed database including an artificial intelligence model associated with anomaly detection, obtaining the artificial intelligence model from the distributed database, and performing a root cause analysis based on the artificial intelligence model.

Example 26 includes the method of example 25, wherein the artificial intelligence model is a first artificial intelligence model, and including obtaining a second artificial intelligence model from the distributed database, the second artificial intelligence model associated with prediction of a next device state based on a current device state, and performing the root cause analysis based on the first artificial intelligence model and the second artificial intelligence model.

Example 27 includes the method of example 26, wherein the performing of the root cause analysis includes obtaining an output of the first artificial intelligence model based on one or more device metrics input to the first artificial intelligence model, the one or more device metrics associated with the compute device, initiating a path analysis of a graph based on the output of the first artificial intelligence model to determine the current device state of the compute device, the graph representative of potential states and state transitions associated with the compute device, the path analysis based on logged data associated with the compute device, and predict the next device state of the compute device based on the current device state of the compute device and the second artificial intelligence model.

Example 28 includes the method of example 27, wherein the performing of the root cause analysis includes querying the distributed database for a recipe to identify a root cause associated with the predicted next device state of the compute device, the querying based on the predicted next device state of the compute device and a device inventory associated with the compute device.

Example 29 includes the method of example 27, wherein the swarm of compute devices is a first swarm of compute devices, and the performing of the root cause analysis includes communicating with a second compute device included in a second swarm of compute devices to obtain a recipe after an unsuccessful query of the distributed database, the recipe to identify a root cause associated with the predicted next device state of the compute device.

Example 30 includes the method of example 28 or example 29, including causing the compute device to perform at least one of a cold start or an auto-recovery procedure based on the recipe, and downloading the artificial intelligence model from the distributed database.

Example 31 includes the method of any one of examples 25 to 28, including detecting a second compute device has joined the swarm of compute devices, initiating a similarity computation based on detection of the second compute device, and causing the swarm of devices to split into a first swarm of compute devices and a second swarm of compute devices based on the similarity computation.

Example 32 includes the method of any one of examples 25 to 28, wherein the joining the swarm of compute devices includes communicating with a second compute device in the swarm of compute devices, the communicating to occur based on an out-of-band management service without use of an operating system of the compute device.

Example 33 includes the method of any one of examples 25 to 32, including communicating a request to ones of the compute devices in the swarm of compute devices to add first data from the compute device to the distributed database, and evaluating results of the request from the ones of the compute devices in the swarm of compute devices to determine whether the first data is permitted to be added to the distributed database.

Example 34 includes the method of example 33, wherein the results includes respective votes and weights from the ones of the compute devices in the swarm of compute devices, the weights based on similarity computations between the compute device and other ones of the compute devices in the swarm of compute devices.

Example 35 includes the method of example 33 or example 34, wherein the distributed database is based on a blockchain.

Example 36 includes the method of example 25, wherein the swarm of compute devices is a first swarm of compute devices, and including accessing a communication from a second compute device included in a second swarm for a recipe to identify a root cause associated with a predicted next device state of the second compute device, querying the distributed database for the recipe, and communicating the recipe to the second compute device.

Example 37 includes the method of example 25, including dynamically managing membership in the swarm based on at least one of a clustering algorithm, a target number of devices per device swarm, or an update frequency.

Example 38 includes the method of any one of examples 25 to 37, wherein the artificial intelligence model is an autoencoder model.

Example 39 includes the method of any one of examples 25 to 38, including communicating a training request to ones of the compute devices in the swarm of compute devices, the training request associated with training the artificial intelligence model, identifying, based on responses to the training request, a subset of one or more of the compute devices to participate in the training of the artificial intelligence model, causing the subset of the compute devices to locally train the artificial intelligence model, and updating the artificial intelligence model based on local training results from the subset of the compute devices.

Example 40 includes the method of any one of examples 25 to 28, including accessing a training request from a second compute device in the swarm of compute devices, the training request associated with training the artificial intelligence model, determining availability of the compute device to participate in the training of the artificial intelligence model, and communicating a response to the second compute device, the response based on the determined availability of the compute device.

Example 41 includes the method of example 40, wherein the determining of the availability of the compute device is based on a long short-term memory model, the long short-term memory model trained to estimate device usage based on historical data.

Example 42 includes the method of example 40, including initiating local training of the artificial intelligence model based on a communication from a second compute device in the swarm of compute devices, and transmitting a result of the local training to the second compute device.

Example 43 includes at least one machine-readable medium comprising machine-readable instructions to cause at least one programmable circuit to perform the method of any one of examples 25 to example 42.

Example 44 includes an apparatus to perform the method of any one of examples 25 to example 42.

Example 45 includes a method performed by any one of the compute devices of examples 1 to example 18.

Example 46 includes at least one machine-readable medium comprising the machine-readable instructions of any one of the compute devices of examples 1 to example 18 includes

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A compute device comprising:
interface circuitry;
machine-readable instructions; and
at least one programmable circuit to be programmed based on the machine-readable instructions to:
access a swarm of compute devices, the swarm of compute devices to maintain a database including an artificial intelligence model associated with anomaly detection;
obtain the artificial intelligence model from the database; and
perform a root cause analysis based on the artificial intelligence model.

2. The compute device of claim 1, wherein the artificial intelligence model is a first artificial intelligence model, and one or more of the at least one programmable circuit is to perform the root cause analysis based on the first artificial intelligence model and a second artificial intelligence model obtained from the database, the second artificial intelligence model associated with prediction of a next device state based on a current device state.

3. The compute device of claim 2, wherein one or more of the at least one programmable circuit is to is to perform the root cause analysis by:
initiating a path analysis of a graph based on an output of the first artificial intelligence model to determine the current device state of the compute device, the graph representative of potential states and state transitions associated with the compute device, the path analysis based on logged data associated with the compute device, the output of the first artificial intelligence model based on one or more device metrics input to the first artificial intelligence model, the one or more device metrics associated with the compute device; and
predicting the next device state of the compute device based on the current device state of the compute device and the second artificial intelligence model.

4. The compute device of claim 3, wherein to perform the root cause analysis, one or more of the at least one programmable circuit is to query the database for a recipe to identify a root cause associated with the predicted next device state of the compute device, the query based on the predicted next device state of the compute device and a device inventory associated with the compute device.

5. The compute device of claim 3, wherein the swarm of compute devices is a first swarm of compute devices, and to perform the root cause analysis, one or more of the at least one programmable circuit is to cause communication with a second compute device included in a second swarm of compute devices to obtain a recipe after an unsuccessful query of the database, the recipe to identify a root cause associated with the predicted next device state of the compute device.

6. The compute device of claim 1, wherein one or more of the at least one programmable circuit is to:
detect a second compute device has joined the swarm of compute devices;
initiate a similarity computation based on detection of the second compute device; and
cause the swarm of devices to split into a first swarm of compute devices and a second swarm of compute devices based on the similarity computation.

7. The compute device of claim 1, wherein to join the swarm of compute devices, one or more of the at least one programmable circuit is to cause communication with a second compute device in the swarm of compute devices, the communication to occur based on an out-of-band management service without use of an operating system of the compute device.

8. The compute device of claim 1, wherein one or more of the at least one programmable circuit is to:
cause communication of a request to ones of the compute devices in the swarm of compute devices to add first data from the compute device to the database; and
evaluate results of the request from the ones of the compute devices in the swarm of compute devices to determine whether the first data is permitted to be added to the database.

9. The compute device of claim 8, wherein the results includes respective votes and weights from the ones of the compute devices in the swarm of compute devices, the weights based on similarity computations between the compute device and other ones of the compute devices in the swarm of compute devices.

10. The compute device of claim 1, wherein the artificial intelligence model is an autoencoder model.

11. The compute device of claim 1, wherein one or more of the at least one programmable circuit is to:
cause communication of a training request to ones of the compute devices in the swarm of compute devices, the training request associated with training the artificial intelligence model;
identify, based on responses to the training request, a subset of one or more of the compute devices to participate in the training of the artificial intelligence model;
cause the subset of the compute devices to locally train the artificial intelligence model; and
update the artificial intelligence model based on local training results from the subset of the compute devices.

12. The compute device of claim 1, wherein one or more of the at least one programmable circuit is to:
access a training request from a second compute device in the swarm of compute devices, the training request associated with training the artificial intelligence model;
determine availability of the compute device to participate in the training of the artificial intelligence model; and
cause communication of a response to the second compute device, the response based on the determined availability of the compute device.

13. The compute device of claim 12, wherein one or more of the at least one programmable circuit is to determine the availability of the compute device based on a long short-term memory model, the long short-term memory model trained to estimate device usage based on historical data.

14. The compute device of claim 12, wherein one or more of the at least one programmable circuit is to:
initiate local training of the artificial intelligence model based on a communication from a second compute device in the swarm of compute devices; and
cause transmission of a result of the local training to the second compute device.

15. At least one non-transitory machine-readable storage medium comprising instructions to cause at least programmable circuit of a compute device to at least:
cause the compute device to join a swarm of compute devices;
access a distributed database shared among the swarm of compute devices, the distributed database including an artificial intelligence model and one or more recipes associated with root cause analyses to be performed by the swarm of compute devices; and
perform at least one of the root cause analyses at the compute device based on the artificial intelligence model and the one or more recipes.

16. The at least one non-transitory machine-readable storage medium of claim 15, wherein to perform the at least one of the root cause analyses, the instructions are to cause one or more of the at least one programmable circuit to:
predict an anomaly occurrence based on the artificial intelligence model and one or more device metrics of the compute device;
determine, based on the predicted anomaly occurrence, a current device state of the compute device;
predict a next device state of the compute device;
query the distributed database for a first one of the one or more recipes that identifies a root cause associated with the predicted next device state of the compute device, the query based on the predicted next device state of the compute device and a device inventory associated with the compute device; and
cause performance of an action based on the first one of the one or more recipes.

17. The at least one non-transitory machine-readable storage medium of claim 15, wherein to perform the at least one of the root cause analyses, the instructions are to cause one or more of the at least one programmable circuit to:
detect a second compute device has joined the swarm of compute devices;
initiate a similarity computation based on detection of the second compute device, the similarity computation based on device inventories of ones of the compute devices in the swarm of compute devices; and
cause the swarm of devices to split into a first swarm of compute devices and a second swarm of compute devices based on the similarity computation.

18. A compute device comprising:
means for forming a swarm of compute devices; and
means for performing a root cause analysis based on an artificial intelligence model from a distributed database maintained by the swarm of compute devices.

19. The compute device of claim 18, wherein the means for forming is to:
detect a second compute device has joined the swarm of compute devices;
initiate a similarity computation based on detection of the second compute device, the similarity computation based on device inventories of ones of the compute devices in the swarm of compute devices; and
cause the swarm of devices to split into a first swarm of compute devices and a second swarm of compute devices based on the similarity computation.

20. The compute device of claim 18, wherein the means for performing the root cause analysis is to:
predict an anomaly occurrence at the compute device based on the artificial intelligence model;
determine, based on the predicted anomaly occurrence, a current device state of the compute device;
query the distributed database for a first one of the one or more recipes that identifies a root cause associated with a predicted next device state of the compute device, the query based on the predicted next device state of the compute device and a device inventory associated with the compute device; and
cause performance of an action based on the first one of the one or more recipes.
